(19) United States
(12) Patent Application Publication
(10) Pub. No.: US 2022/0247808 A1
(43) Pub. Date: Aug. 4, 2022

(54) CONTENT DISTRIBUTION NETWORK CONTROL BASED ON NETWORK MEASUREMENT DATA

(71) Applicant: ASSIA SPE, LLC, Wilmington, DE (US)

(72) Inventor: Chan-Soo Hwang, Seoul (KR)

(73) Assignee: ASSIA SPE, LLC, Wilmington, DE (US)

(21) Appl. No.: 17/220,928

(22) PCT Filed: Oct. 1, 2019
(86) PCT No.: PCT/US2019/054135

§ 371 Date: Apr. 2, 2021

Related U.S. Application Data
(60) Provisional application No. 62/740,349, filed on Oct. 2, 2018.

(51) Int. Cl. H04L 65/612; H04L 65/613; H04L 65/75; H04L 65/80

(52) U.S. Cl. CPC H04L 65/612; H04L 65/80; H04L 65/762; H04L 65/613

(57) ABSTRACT

Various embodiments of the invention relate to system and method for controlling data streaming rate in a content distribution network (CDN) based on the network performance measurement. Embodiments of the system involve estimating a maximum stable rate for streaming data and sending a media control packet including the maximum stable rate to a CDN gateway on a user-side device. Based on the maximum stable rate, a media server may adjust the streaming rate of the media file segments. Upon receiving the media control packet, the CDN gateway read the maximum stable rate and may reduce the instantaneous streaming speed if the current streaming rate is higher than the maximum stable rate. Alternatively, in response to the current streaming rate being much less than the maximum stable rate, the media server increases the instantaneous rate.

### CROSS-REFERENCE TO RELATED APPLICATIONS

This application claims the priority benefit under 35 USC § 119(e) to U.S. Provisional Patent Application No. 62/740,349, entitled “CONTENT DISTRIBUTION NETWORK CONTROL BASED ON NETWORK MEASUREMENT DATA,” naming Chan-Soo Hwang as inventor, and filed Oct. 2, 2018, and to the PCT Patent Application No. PCT/US2019/054135, entitled “CONTENT DISTRIBUTION NETWORK CONTROL BASED ON NETWORK MEASUREMENT DATA,” naming Chan-Soo Hwang as inventor, and filed Oct. 1, 2019. The aforementioned patent document is incorporated by reference herein in its entirety.

### A. Technical Field

The present invention relates to controlling data transfer rate in a network, and more particularly, to controlling data streaming rate in a content distribution network (CDN) based on the network performance.

### B. Description of the Related Art

CDN refers to a network that resides in various locations in the Internet to distribute Internet contents with high performance. One of the primary applications of CDN is to provide media (audio and video) streaming services to the users. Recently, more users use Wi-Fi connection to get the streaming services at home; therefore, may suffer from the variation of Internet connections speed. Moreover, especially in home network with limited wide-area-network (WAN) speed or congested Wi-Fi connections, the media streaming services suffer from the impact of cross traffic, which is the traffic generated by other users sharing the same WAN/Wi-Fi connections.

To resolve the problems, most of the popular streaming services use the HTTP(S) streaming protocol, where the media file is divided into small segments, and then is transported to the client as a sequence of hypertext transfer protocol (HTTP)(S) file downloads. FIG. 1 shows a schematic diagram of a conventional media streaming system 100 based on the HTTP streaming protocol. As depicted, a video streaming server (or shortly server) 102 divides the media file into multiple segments 106a-106n, and each segment is sequentially sent to the client-side device 104.

The speed estimator 112 of the client-side device 104 determines the network download speed of each segment based on the size of the previous segment(s) and the download time. Based on the download speed of the previous segment (e.g. 106a), the client-side device updates the streaming rate (or equivalently, download speed) for the ensuing segments (e.g. 106b) at every segment. Then, based on the determined download speed, the quality adjustor 114 determines the quality (such as high definition (HD) or standard definition (SD)) of the ensuing segment and sends the information of the streaming rate and quality to the server 102 via the HTTP GET command 116.

The client-side device 104 estimates the speed of the connection between the server 102 and the client-side device 104 (i.e., network download speed) based on the download speed of the previous segment(s). The estimated speed is usually inaccurate because a new TCP/IP connection may need to be set-up for each segment and the estimation is affected by the slow-start behavior of the transmission control protocol/internet protocol (TCP/IP) connection. Especially when the segment size is small, this estimate tends to under-estimate the true connection speed.

In general, inaccurate speed estimate causes two problems. First, the packet loss events due to the cross traffic tend to create a feedback loop to set the streaming speed significantly less than what would have been the fair sharing of traditional TCP flow control. In other words, the HTTP(S) streaming protocol tends to reduce the streaming speed less than the half of the Internet speed, which is the fair sharing speed of TCP flows. Second, because the speed measurement is based on instantaneous estimation, the rate adaptation tends to create the fluctuation of quality of media, which creates bad user experience. If the initial streaming started when the communication channel (e.g. Wi-Fi) is not congested, the streaming can start with HD quality (e.g. segment 106a in FIG. 1) and then, as the Wi-Fi becomes congested, the quality continue to degrade to a lower quality (e.g. segment 106b in FIG. 1). This brings a worse user experience compared to the case when the media was consistently played at HD quality. This problem is not only limited to the HTTP(S) streaming protocol such as Dynamic Adaptive Streaming over HTTP (DASH) and Akamai HD, but also any other applications that split the large file into smaller segments and then transmit the segments periodically over the Internet with adaptive rate, such as network game, web conferencing, and p2p.

Several attempts have been made to resolve this problem by using more accurate estimate of Internet speed. For example, the download speed is estimated using longer term average and smoothing. In another example, the VideoLan Client (VLC) player, a popular open source player supporting DASH, uses exponentially weighted moving average filter, which is an adaptive one-tap infinite impulse response (IIR) filter, to smooth the speed estimate. However, these approaches cannot estimate whether the current Internet speed can be sustained for the entire duration of media streaming. In addition, the longer term averaging can slow down the adaptation speed, which can cause the buffer underrun and pause the media stream.

As such, there is a need for methods and systems that can control the media streaming rate based on more accurate estimate of the network performance.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a schematic diagram of a conventional media streaming system based on the HTTP streaming protocol.

FIG. 2 shows a schematic diagram of a network system according to embodiments of the present disclosure.

FIG. 3 shows a schematic diagram of a client-side device according to embodiments of the present disclosure.

FIG. 4 shows a schematic diagram of a client-side device according to embodiments of the present disclosure.

FIG. 5 shows a schematic diagram of a media control packet according to embodiments of the present disclosure.

FIG. 6 shows a schematic diagram of a network system according to embodiments of the present disclosure.

FIG. 7 shows a flowchart of an illustrative process for adjusting media streaming rate according to embodiments of the present disclosure.

FIG. 8 shows a flowchart of an illustrative process for adjusting a media streaming rate by a media server according to embodiments of the present disclosure.

FIG. 9 shows a computer system according to embodiments of the present disclosure.

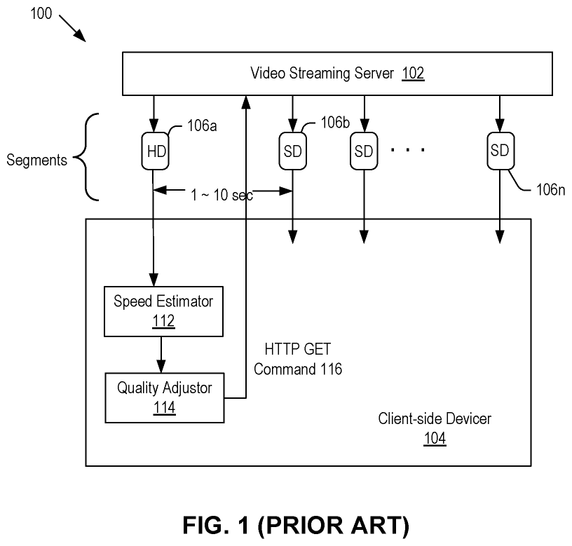

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as software, hardware, firmware or a combination thereof.

Furthermore, connections between components within the figures are not intended to be limited to direct connections. Rather, data between these components may be modified, reformatted, or otherwise changed by intermediary components or devices. Also, additional or fewer connections may be used. It shall also be noted that the terms “coupled” “connected” or “communicatively coupled” shall be understood to include direct connections, indirect connections through one or more intermediary devices, and wireless connections.

Furthermore, one skilled in the art shall recognize: (1) that certain steps may optionally be performed; (2) that steps may not be limited to the specific order set forth herein; and (3) that certain steps may be performed in different orders, including being done contemporaneously.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

The use of certain terms in various places in the specification is for illustration and should not be construed as limiting. A service or function is not limited to a single service, or function; usage of these terms may refer to a grouping of related services or functions, which may be distributed or aggregated.

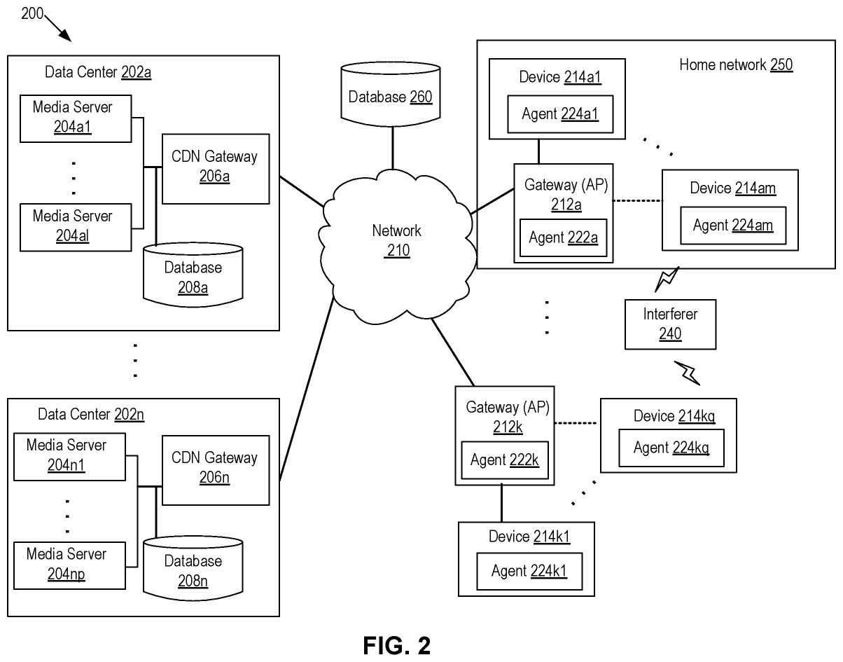

FIG. 2 shows a schematic diagram of a network system 200 according to embodiments of the present disclosure. As depicted, one or more data centers 202a-202n may provide media (audio and video) streaming services to devices 214a1-214kq through a network 210. In embodiments, a data center (e.g. 202a) may include: one or more media servers 204a1-204al, such as DASH servers; a CDN gateway 206a coupled to the media servers; and a database 208a. Similarly, in embodiments, a data center (e.g. 202n) may include: one or more media servers 204n1-204np; a CDN gateway 206n coupled to the media servers; and a database 208n. It is noted that each data center may include other suitable number of CDN gateways and databases.

In embodiments, each data center may transmit streaming data to one or more gateways, such as Wi-Fi access points, 212a-212k on the client side through a wireless communication channel and/or a wire communication channel, such as cable or DSL line. In embodiments, each gateway (e.g. 212a) may relay the received streaming data to one or more of the devices 214a1-214am through wire or wireless communication channel(s). In embodiments, the devices may be user devices, such as PCs, cell phones, or any mobile devices that each have a capability to display the streaming data to a user. In some cases, the two or more devices 214k1-214kq may simultaneously access the gateway 212k through the same channel, which may increase the level of cross traffic on the channel. In other cases, the interferer 240, such as a neighbor's user device, may wirelessly communicate with a Wi-Fi access point that is not a part of the system 200, causing interference to a communication channel between the device (e.g. 214am) and the gateway 212a.

As discussed above, the conventional systems use the streaming rate of the instantaneous or previous media file segment(s) to estimate the streaming rate of the ensuing media file segment. In marked contrast, in embodiments, additional network QoS parameters are measured and used to estimate the streaming rate of ensuing media file segment(s). More specifically, one or more agents 222a-222k and 224a1-224kq may be included in gateways 212a-212k and devices 214a1-214kq, respectively, monitor the overall communication performance and measure various parameters related to network QoS. In embodiments, the parameters may include; the broadband speed, Wi-Fi speed, the historical occurrences of interferers and cross traffic, latency between streaming file segments, and other metrics related to network QoS. (Hereinafter, these parameters measured by the agent(s) are termed as outside streaming parameters since these parameters do not include the streaming rate of instantaneous or previous streaming file segments.) In embodiments, the agent(s) may also measure the streaming rates of streaming file segments, as in the conventional systems. Then, using the information of the outside streaming parameters, the streaming rates of ensuing media file segments may be estimated.

In one embodiment, the agent (e.g. 222a) may be included in a Wi-Fi access point (e.g. 212a) of a home network and measure the QoS parameters of the entire home network, where the parameters may include the usage pattern of devices (e.g. 214a1-214am) within the home network 250. In another embodiment, this measurement may be performed by the agent 224am that is able to provide the media streaming service to a user. In both cases, the agent(s) may monitor and measure the network QoS even when the streaming service is not turned on. In embodiments, the information of the parameters measured by the agents 222a-222k and 224a1-224kq may be stored in a database 260. It is noted that the database 260 may be located at any suitable place where the agents can access. It is noted that the agent may be located in other suitable locations, such as DSL modem, cable mode, media gateway, Wi-Fi router, cellular base station, and so forth.

In embodiments, based on the measurements, each agent may estimate the maximum stable rate of the streaming service. In embodiments, this maximum stable rate may be the download speed of the streaming data, in consideration of the effects of both Internet and and Wi-Fi, where the maximum stable rate needs to be sustained for the duration of media streaming. In embodiments, if the duration of the streaming is unknown, the agent may output multiple maximum stable rates that correspond to different streaming durations. It is noted that the maximum stable rate may be computed based on the information of the network QoS parameters measured by the agent(s).

In embodiments, based on the measurements of the QoS parameters, each agent may estimate the minimum stable latency (or minimum stable RTT) of the streaming service. In embodiments, the minimum stable latency may be the latency of the network that can be sustained during the entire session of an application. For example, for example, if a game requires latency of 5 ms to support a certain mode of operation while the minimum stable latency is 10 ms, the game may adapt the speed such that the latency requirement is around 10 ms.

By way of example, the agent 222a and/or 224am may measure the intensity of interference signal from the interferer 240 over a certain period of time to determine the variation of interference intensity during one day cycle. If the intensity is high during 9:00 PM-9:30 PM, the media file segments may be transmitted at a lower speed during the time period. In another example, the agent 222a may measure the level of cross traffic to determine the variation of the level during one day cycle. If the level is high during 7:00 PM-11:00 PM, the download speed of streaming data to each of the devices 214a1-214am may be adjusted to a lower rate during the time period. In embodiments, the agent 222a and/or 224am may measure historical occurrences of other parameters, such as latency between streaming file sequences.

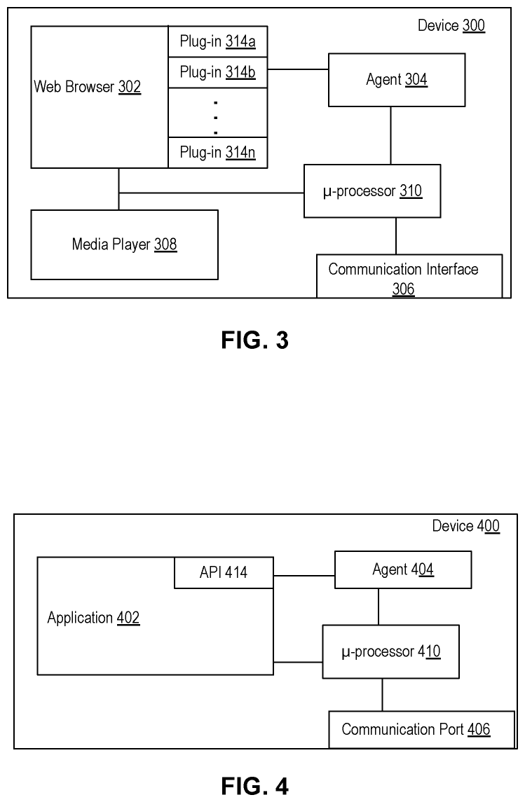

In embodiments, when a streaming session is set-up between a media server and a user-side device, the information of the maximum stable rate that is estimated by an agent may be sent to CDN (or media server). In embodiments, the information of the maximum stable rate may be embedded in a media control packet, such as connection request. FIG. 3 shows a schematic diagram of a client-side device 300 according to embodiments of the present disclosure. In embodiments, the device 300 may be similar to the devices 214 in FIG. 2 and include: a μ-processor 310; an agent 304 that may be similar to the agents 224; a media player 308 for playing media contents to a user; a communication interface 306 for receiving/sending signals; and a web browser 302 for receiving and providing streaming data to the media player 308. In embodiments, the agent 304 may be a software, a hardware, a firmware or a combination thereof.

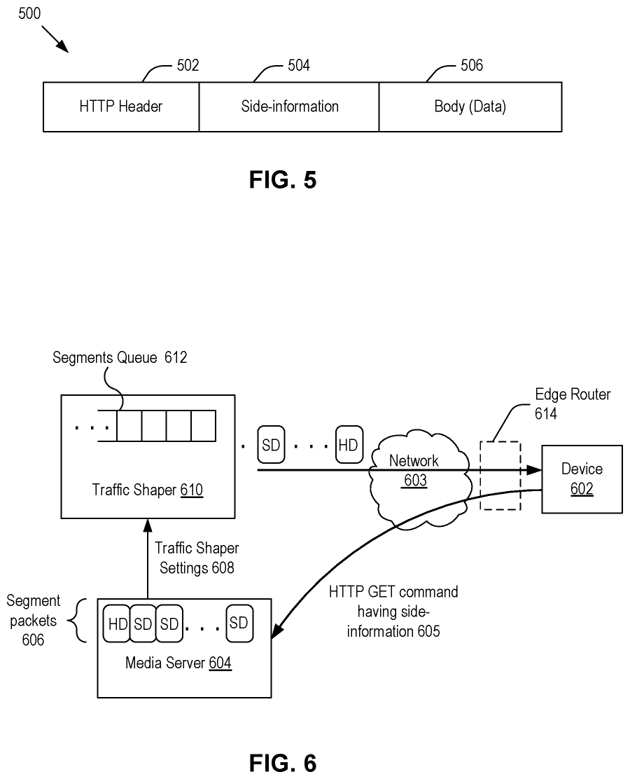

In embodiments, the agent 304 may measure the network QoS parameters using the signals received through the communication interface 306, where the network QoS parameters may include the outside streaming parameters. Then, using the information of measured network QoS parameters, the agent 304 may estimate the maximum stable rate and send the information of the maximum stable rate to a plug-in (e.g. 314b) of the web browser 302. In embodiments, the plug-in 314b may have a function to add the maximum stable rate information to a proprietary header of a media control packet, such as HTTP GET command, that is sent to the CDN (or media server). FIG. 5 shows a schematic diagram of a media control packet 500 according to embodiments of the present disclosure. As depicted, the media control packet, such as HTTP GET command, may include HTTP header 502, side-information 504 and body (or data associated with the command) 506. (For the purpose of illustration, the terms HTTP GET command and media control packet are used interchangeably. However, it should be apparent to those of ordinary skill in the art that the media control packet may have other suitable format than HTTP GET command.) The plug-in 314b may add the side-information to the command, where the side-information may include the maximum stable rate received from the agent 304, as well as other information, such as current streaming rate, current round-trip delay time (RTT), and so on.

In embodiments, for an unencrypted connection between the media server (e.g. 204a) and device (e.g. 214am), the side-information 504 may be added by the gateway, such as Wi-Fi access point, 212a. In embodiments, the agent 222a included in the gateway 212a may perform the functions of the agent 304, i.e., the agent may measure the network QoS parameters, estimate the maximum stable rate and add side-information to the media control packet 500. It is noted that the command 500 in FIG. 5 includes the HTTP header 502, which is used for an unencrypted connection between the media server and device.

In embodiment, for an encrypted connection, such as HTTPS, between the media server and the user-side device, the side-information 504 may be added at the application layer program, such as web-browser 302 of the user-side device.

FIG. 4 shows a schematic diagram of a client-side device 400 according to embodiments of the present disclosure. As depicted, the device 400 may be similar to the devices 214 and include: a μ-processor 410; an agent 404 that may be similar to the agents 224; an application 402 for receiving media streaming data and playing the media contents to a user; an application program interface 414; and a communication interface 406 for receiving/sending signals. In embodiments, the agent 404 may be a software, a hardware, a firmware or a combination thereof.

In embodiments, the agent 404 may measure the network QoS parameters using the signals received through the communication interface 406, where the network QoS parameters may include outside streaming parameters. Then, using the information of the measured network QoS parameters, the agent 404 may estimate the maximum and minimum stable rates and send the information of the maximum (and minimum) stable rate to the API 414. In embodiments, the API 414 may have a function to add the side-information (that includes the maximum stable rate information) to a proprietary header of a media control packet that is similar to the command 500 and sent to the CDN (or media server).

By embedding the side-information 504 in the media control packet 500, the media server (e.g. 204a) may quickly respond to the information. In embodiments, in case the embedding is not allowed, the maximum stable rate information may be stored in the database (e.g. 208a) and the media server may query the information. It is noted that the database 208a may be located inside the corresponding media servers (e.g. 204a1) or any other suitable location that can be readily accessed by the media server 204a1.

In embodiments, when the CDN gateway (or media server) receives the media control packet 500, the maximum stable rate information embedded in the side-information 504 may be used to set the maximum and minimum download speed of the session. FIG. 6 shows an operational block diagram of a network system according to embodiments of the present disclosure. As depicted, the device 602, which may be similar to the gateway 212 or user-side device 214, may send a media control packet 605, such as HTTP GET command 500, to the media server 604, which may be similar to the media servers 204, through the network 603. In embodiments, the media server 604 may read the maximum stable rate information included in the media control packet 605, and derive traffic shaper settings 608 based on the maximum stable rate. In embodiments, the media server 604 may have segment packets 606 and send one or more of the segment packets 606 to the traffic shaper 610 along with the traffic shaper settings 608.

In embodiments, the traffic shaper 610 may input the received segment packet(s) into a segment queue 612. Then, according to the traffic shaper setting 608, the traffic shaper 610 may control the speed for transmitting one or more segments in the segment queue 612 to the device 602 via the network 603. In embodiment, the traffic shaper 606 may use the traffic shaper settings 608 to set the maximum transmit window size of the TCP connection to limit the download speed. In embodiments, the traffic shaper 610 may add delay to the TCP connection to lower the connection speed to be below the maximum stable rate. Because of this speed limit, the client-side device 602 may set the streaming speed to be lower than the limit. In embodiments, the traffic shaper 610 may drop packets in the segment queue 612 to lower the streaming speed. In embodiments, the traffic shaper 610 may be located in the CDN gateway 206, or an edge router 614 (if there is any edge router between the network 603 and the device 602), or the gateway 212, or any other suitable network element in the network 603.

In embodiments, the CDN gateway (e.g. 206a) may want to compel the device 602 to increase the download speed. For example, if the client-side device 602 continues to request maximum stable rates that are much smaller than the allowable streaming rate, the CDN gateway may change the TCP configurations to use more aggressive window scaling. In another example, the CDN gateway may reduce the added delay that were used to limit the TCP connection speed.

As discussed above, the agent (222 or 224) may use the information of the network QoS parameters to estimate the maximum stable rate. For example, based on the historical speed test measurement, the agent may select a rate with which the probability that the connection speed is lower than the rate during T seconds for entire media streaming is less than a preset value P. The time duration T may be set based on the buffer size of the player (e.g. 308). In embodiments, P may be set based on the cost of rate adaptation in terms of user experience.

In embodiments, to estimate the maximum stable rate, the agent may consider the historical distribution of Wi-Fi interferers during one day cycle. For example, if the device 214am plays a media content in the evening when there have been many interferers in the past, the agent 224am may reduce the maximum stable rate to compensate for the probability of experiencing severe interferences. In another example, to estimate the maximum stable rate, the agent 222a may consider the historic distribution of cross-traffic during the projected play time. In embodiments, to estimate the maximum stable rate, the agent 222a may consider the location of the device 214am, the IP address and/or the MAC address of the access point gateway 212a, such that the maximum stable rate may be adapted to different network topologies.

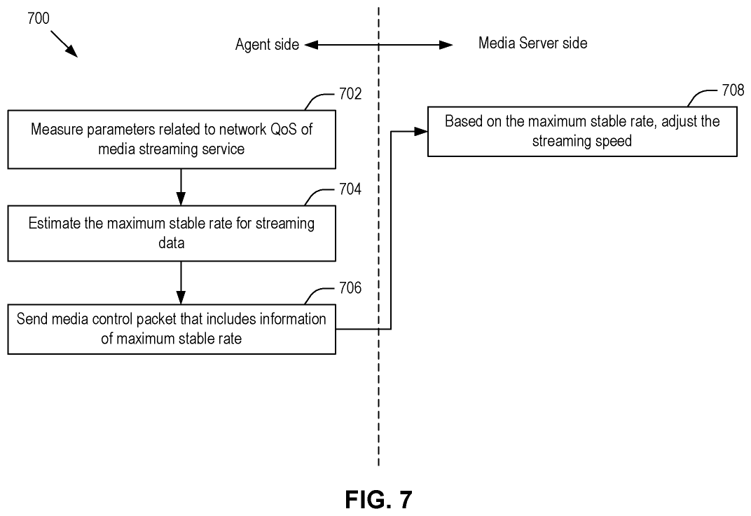

FIG. 7 shows a flowchart 700 of an illustrative process for adjusting streaming rate according to embodiments of the present disclosure. As depicted, at step 702, the agent (222 or 224) may measure parameters related to the network QoS of a media streaming service. In embodiments, the parameters may include: the broadband speed, Wi-Fi speed, the historical occurrences of interferers and cross traffic, latency between streaming file segments, and other metrics related to network QoS.

At step 704, the agent (e.g. 224am) may estimate the maximum stable rate for streaming data. At step 706, the user-side device (e.g. 214am) that includes the agent 224am may send a media control packet, such as HTTP GET command 500, that includes the information of the maximum stable rate to the CDN gateway (e.g. 206a). Based on the maximum stable rate, the media server (e.g. 204a1) may adjust the streaming rate of the media file segments, at step 708.

In case the client-side device 214am is receiving the media file segments at the maximum stable rate, steps 706 and 708 may not be necessary. Instead of performing these two steps, the client-side device 214am may maintain the current streaming rate to download the ensuing file segments.

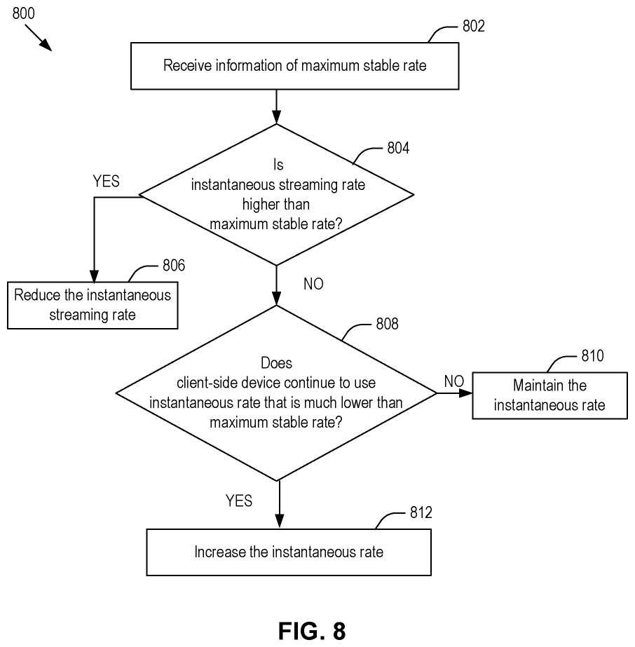

FIG. 8 shows a flowchart 800 of an illustrative process for adjusting a streaming rate by a media server according to embodiments of the present disclosure. In embodiments, the flowchart 800 may correspond to step 708 in FIG. 7. As depicted, the process may start at step 802. At step 802, the CDN gateway (e.g. 206a) may receive the media control packet 500 and read the information of the maximum stable rate. Then, at step 804, the media server (e.g. 204a1) may determine if the current streaming rate is higher than the maximum stable rate. If the answer to the determination is positive, the flow proceeds to step 806.

At step 806, the media server may reduce the instantaneous streaming speed. In embodiments, the traffic shaper 606 in the server may limit the streaming rate using the maximum stable rate. In embodiments, the maximum stable rate may be used to set the maximum transmit window size of the TCP connection to limit the streaming speed. In embodiments, the CDN may add delay to the TCP connection to lower the connection speed to be below the maximum stable rate. In embodiments, the traffic shaper 606 may drop packets in the file segment queue 604.

If the answer to the determination at step 804 is negative, the process proceeds to step 808. At step 808, it is determined whether the client-side player 308 continues to use instantaneous streaming rate that is much lower than the maximum stable rate (determining whether the instantaneous streaming rate is much lower than the maximum stable rate for a certain duration). For example, the instantaneous streaming rate is much lower than the maximum stable rate when the instantaneous streaming rate is less than half of the maximum stable rate. The “much lower” requirement ensures a margin to prevent error in the estimation. Furthermore, the duration requirement ensures that a rate increase decision is not based on an instantaneous or single observation. Upon the negative answer to step 808, the process proceeds to step 810. At step 810, the media server 204a1 may maintain the instantaneous streaming rate to download ensuing file segments, i.e. the media server 204a may send file segments at the current streaming rate.

Upon the positive answer to step 808, the process proceeds to step 812. At step 812, the media server 204a1 may increase the instantaneous rate. In embodiments, the traffic shaper 606 may reduce the delay added to the TCP connection to thereby increase the streaming rate. In embodiments, the media server 204a1 may want compel the client-side device to increase the speed. For example, if the client-side device 214am continues to request maximum stable rates that are much lower than an allowable rate, the media server 204a may change the TCP configurations to use more aggressive window scaling. In another example, the media server 204a1 may reduce the added delay that were used to limit the TCP connection speed.

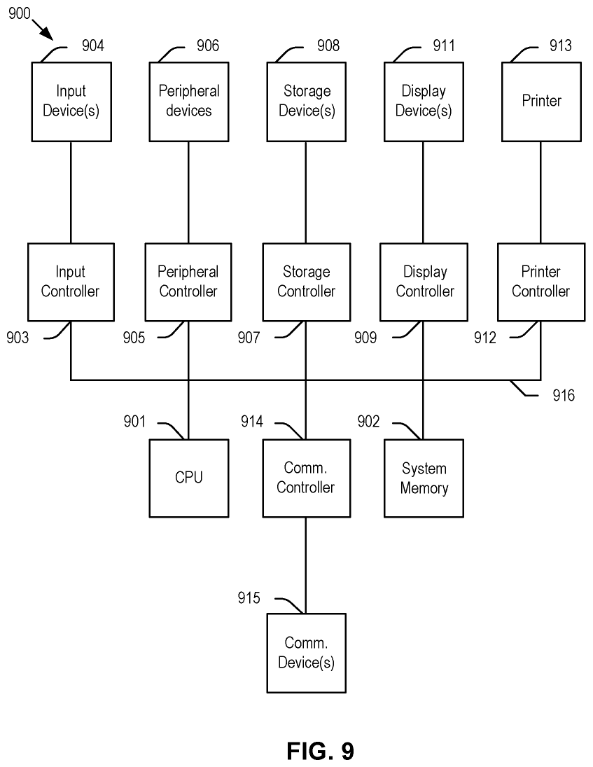

FIG. 9 depicts a simplified block diagram of a computing system 900 that may be used in the system 200 according to embodiments of the present disclosure. It will be understood that the functionalities shown for system 900 may operate to support various embodiments of an information handling system (or node)—although it shall be understood that an information handling system may be differently configured and include different components. As illustrated in FIG. 9, system 900 includes a central processing unit (CPU) 901 that provides computing resources and controls the computer. CPU 901 may be implemented with a microprocessor or the like, and may also include a graphics processor and/or a floating point coprocessor for mathematical computations. System 900 may also include a system memory 902, which may be in the form of random-access memory (RAM) and read-only memory (ROM).

A number of controllers and peripheral devices may also be provided, as shown in FIG. 9. An input controller 903 represents an interface to various input device(s) 904, such as a keyboard, mouse, or stylus. There may also be a scanner controller 905, which communicates with a scanner 906. System 900 may also include a storage controller 907 for interfacing with one or more storage devices 908 each of which includes a storage medium such as magnetic tape or disk, or an optical medium that might be used to record programs of instructions for operating systems, utilities and applications which may include embodiments of programs that implement various aspects of the present invention. Storage device(s) 908 may also be used to store processed data or data to be processed in accordance with the invention. System 900 may also include a display controller 909 for providing an interface to a display device 911, which may be a cathode ray tube (CRT), a thin film transistor (TFT) display, or other type of display. System 900 may also include a printer controller 912 for communicating with a printer 913. A communications controller 914 may interface with one or more communication devices 915, which enables system 900 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

1. A method for controlling data streaming rate in a content distribution network (CDN), the method comprising:
measuring, at a user-side device, one or more parameters related to network quality of service (QoS) of a data streaming service;
estimating, at the user-side device, a maximum stable rate for streaming data based on the measured one or more parameters;
sending a control packet embedding with the maximum stable rate to a server coupled to the user-side device via a network connection; and
adjusting, at the server, data streaming rate of one or more files or file segments based on the maximum stable rate.

2. The method of claim 1 wherein the one or more parameters comprise at least one of
broadband speed;
Wi-Fi speed;
historical occurrences of interferers and cross traffic; or
latency between streaming file segments.

3. The method of claim 2 wherein the one or more parameters are outside streaming parameters and do not include data streaming rate of instantaneous or previous streaming file segments.

4. The method of claim 1 wherein the maximum stable rate is embedded in a side-information of the control packet at an application layer program of the user-side device.

5. The method of claim 1 wherein the maximum stable rate is embedded in a side-information of the control packet by a user-side gateway when the server couples to the user-side device via an unencrypted connection.

6. The method of claim 1 wherein the maximum stable rate is a download speed for streaming data to be sustained for a duration of data streaming.

7. The method of claim 1 adjusting, at the server, data streaming rate of one or more files or file segments based on the maximum stable rate further comprising:
determining if a current data streaming rate is higher than the maximum stable rate;
in response to the current data streaming rate being higher than the maximum stable rate, reducing the current data streaming rate; and
in response to the current data streaming rate being continuously lower than the maximum stable rate, increasing the current data streaming rate.

8. The method of claim 7 wherein reducing the current data streaming rate comprises at least one of the following:
setting a maximum transmit window size;
adding delay to the network connection; and
dropping packets in a file segment queue for the data streaming service.

9. The method of claim 7 wherein increasing the current data streaming rate comprises at least one of the following:
reducing delay added to the network connection; and
changing a configuration of the network connection to enlarge window scaling.

10. A method for controlling data streaming rate in a content distribution network (CDN), the method comprising:
receiving, a server, a control packet embedding with a maximum stable rate for data streaming at a user-side device coupled to the server via a network connection; and
determining if a current data streaming rate is higher than the maximum stable rate;
in response to the current data streaming rate being higher than the maximum stable rate, reducing the current data streaming rate; and
in response to the current data streaming rate being lower than the maximum stable rate, maintaining or increasing the current streaming rate.

11. The method of claim 10 wherein the maximum stable rate is embedded in a side-information of the control packet at an application layer program of the user-side device or by a user-side gateway.

12. The method of claim 10 wherein the maximum stable rate is a download speed for streaming data to be sustained for a duration of data streaming.

13. The method of claim 11 wherein in response to the current data streaming rate being lower than the maximum stable rate, maintaining or increasing the current streaming rate comprising:
increasing the current data streaming rate if the current data streaming rate is continuously lower than the maximum stable rate; or
maintaining the current data streaming rate if the current data streaming rate is not continuously lower than the maximum stable rate.

14. The method of claim 10 wherein reducing the current data streaming rate comprises at least one of the following:
setting a maximum transmit window size;
adding delay to the network connection; and
dropping packets in a file segment queue for the data streaming service.

15. The method of claim 10 wherein increasing the current data streaming rate comprises at least one of the following:
reducing delay added to the network connection; and
changing a configuration of the network connection to enlarge window scaling.

16. A system for controlling data streaming rate in a content distribution network (CDN), the system comprising:
a network;
a user-side device coupled to the network, the user-side device measures one or more parameters related to network quality of service (QoS) of a data streaming service, estimates a maximum stable rate for streaming data based on the measured one or more parameters, and sends a control packet embedding with the maximum stable rate;
a server coupled to the user-side device via the network, the server receives the control packet, reads the maximum stable rate, and adjusts data streaming rate of one or more files or file segments based on the maximum stable rate.

17. The system of claim 16 wherein the one or more parameters comprise at least one of
broadband speed;
Wi-Fi speed;
historical occurrences of interferers and cross traffic; or
latency between streaming file segments.

18. The system of claim 17 wherein the one or more parameters are outside streaming parameters and do not include data streaming rate of instantaneous or previous streaming file segments.

19. The system of claim 16 wherein the maximum stable rate is embedded in a side-information of the control packet at an application layer program of the user-side device when the server couples to the user-side device via an encrypted connection.

20. The system of claim 16 wherein the maximum stable rate is embedded in a side-information of the control packet by a user-side gateway when the server couples to the user-side device via an unencrypted connection.
